(19) United States
(12) Patent Application Publication
(10) Pub. No.: US 2007/0235265 A1
(43) Pub. Date: Oct. 11, 2007

(54) Incline Lift Unit with Locking Device and Locking Device Intended for an Incline Lift Unit

(75) Inventor: Dennis Vroegindeweij, Ursem (NL)

Correspondence Address: HOFFMANN & BARON, LLP, 6900 JERICHO TURNPIKE, SYOSSET, NY, 11791, US

(73) Assignee: Freelift b.v.

(21) Appl. No.: 11/628,931

(22) PCT Filed: Jun. 22, 2005
(86) PCT No.: PCT/NL05/00452

§ 371 Date: Dec. 7, 2006

(30) Foreign Application Priority Data
Jun. 24, 2004 (NL) 1026498

(51) Int. Cl. B66B 9/08

(52) U.S. Cl. 187/201

(57) ABSTRACT

An incline lift unit (2) comprises a conveying unit (5), a load unit (4) which is rotatably connected to the latter, a positioning device (20), and a locking device (100). The positioning device is designed to turn the load unit with respect to the conveying unit in such a manner that, in use, the load unit assumes a desired load orientation relative to the force of gravity. The locking device comprises a locking means (133). The locking means locks the rotatable connection between the load unit and the positioning device if the load unit has assumed an undesirable load orientation. The locking device comprises a reference element (131) which is movable with respect to the load unit and the conveying unit, its position with respect to the load unit being determined by the direction of the force of gravity. The load unit is able to assume at least a neutral position and a locking position at the desired and undesired load orientation, respectively, with respect to the reference element. The reference element is mechanically connected to the locking means. The reference element activates the locking means in the locking position.

The invention relates to an incline lift unit according to the preamble of claim 1. An incline lift unit of this type is intended for moving upwards and/or downwards along a guide, such as a track, or rails. This guide extends for example along a staircase and may have a varying angle of inclination.

An incline lift unit of this type is known from WO 95/18763. This document describes a stairlift unit which comprises an undercarriage and a chair. The undercarriage is designed for moving along a guiderail by means of wheels. One of the wheels is designed as a toothed wheel, which can engage on a toothed rack which extends along the guiderail.

The chair is connected to the undercarriage so as to be rotatable. The rotatable connection is driven via a gear connection and a motor. The motor is driven such that the chair has a desired orientation, that is to say vertical, and remains so even when the undercarriage rotates as a result of a changing angle of inclination of the guiderail.

The known stairlift unit is provided with a safety feature, which comprises a locking pin. The locking pin can act on an opening in the support of the chair. The safety device furthermore comprises an electric circuit provided with mercury switches. When the mercury switches detect that the orientation of the chair is starting to tilt undesirably, the locking pin is released which will fall into the hole, influenced by a spring. In this manner, the undesirable rotation of the chair with respect to the undercarriage is limited.

A disadvantage of this known stairlift unit is that the safeguard is dependent on an electric circuit. The components forming part of such circuits are susceptible to failures, which may lead to malfunctions of the safety feature. Since such a safety feature will not be activated during normal use, such a malfunction may only come to light when the safety feature does have to become active. In order to prevent the latter, a safety feature of this type can be provided with test circuits, with associated test procedures. This, however, makes the circuit more complicated and expensive. Another disadvantage is the use of mercury switches, which have been banned from use in many countries.

It is an object of the present invention to provide an incline lift unit, in which these disadvantages have been at least partly eliminated, or to provide a usable alternative.

In particular, it is an object of the invention to provide an incline lift unit which is not susceptible to failures in an electrical system.

According to the invention, this object is achieved by an incline lift unit according to claim 1. An incline lift unit according to the invention comprises a conveying unit, a load unit which is rotatably connected to the latter, a positioning device, and a locking device. The positioning device is designed to turn the load unit with respect to the conveying unit in such a manner that, in use, the load unit assumes a desired load orientation relative to the force of gravity. The locking device comprises a locking means. The locking means locks the rotatable connection between the load unit and the positioning device if the load unit assumes an undesirable load orientation. The locking device comprises a reference element which is movable with respect to the load unit and the conveying unit, its position with respect to the load unit being determined by the direction of the force of gravity. The load unit is able to assume at least a neutral position and a locking position at the desired and undesired load orientation, respectively, with respect to the reference element. The reference element is mechanically connected to the locking means. The reference element activates the locking means in the locking position.

Because the reference element and the locking means are mechanically connected, there is no need for electrical means as in the state of the art, which increases reliability. In addition, a locking device according to the invention does not require a mercury switch.

Expediently, the reference element is fixedly connected to the locking means. This limits the number of parts which are movable relative to one another, which results in a further increase in robustness and thus reliability.

In particular, the reference element can be moved along a curved track relative to the load unit. On account of such a curved track, the reference element will take up a neutral position along this track under the force of gravity, as long as the load has the desired orientation with respect to the force of gravity. As soon as the load orientation differs significantly from the desired orientation, the reference element will, under the force of gravity, continue to search for the lowest point along the curved track and will thus arrive at the locking position.

In one embodiment, the locking device comprises a pendulum to which the reference element is connected. Such a pendulum is a simple and robust embodiment of a locking device.

In another embodiment, the locking device comprises a slot. The reference element can be guided through the slot and can thus assume a position under the influence of the force of gravity which corresponds to the load orientation.

In particular, the reference element is a ball, which is accommodated in the slot so as to be movable. Such a ball in a slot forms a simple locking device.

Advantageously, in the locking position, at least one of the radial and axial positions of the reference element relative to the rotatable connection differs from the corresponding position in the neutral position. This differing position is passed on to the locking means, which, as a result, locks the rotatable connection.

Further embodiments are defined in the subclaims.

The invention furthermore relates to a locking device, clearly intended for an incline lift unit according to claim 11.

Embodiments of the invention will be explained in more detail with reference to the appended drawing, in which:

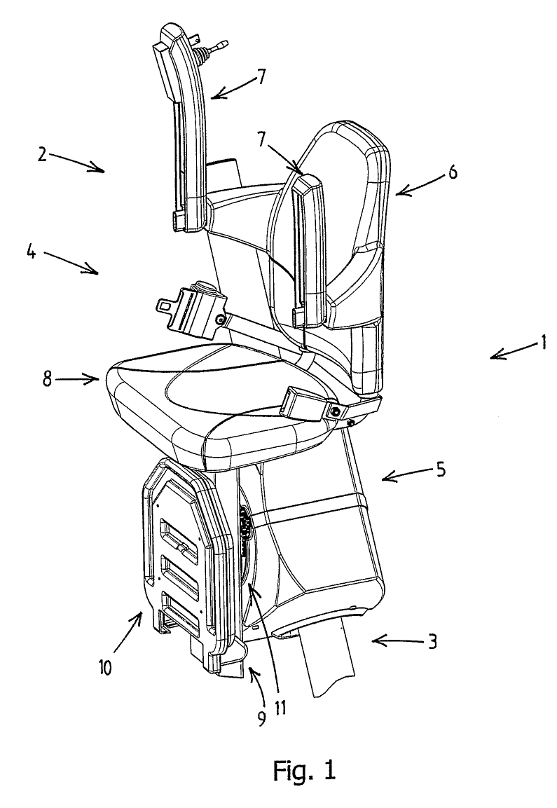

FIG. 1 shows a perspective view of stairlift, with a stairlift unit according to the invention;

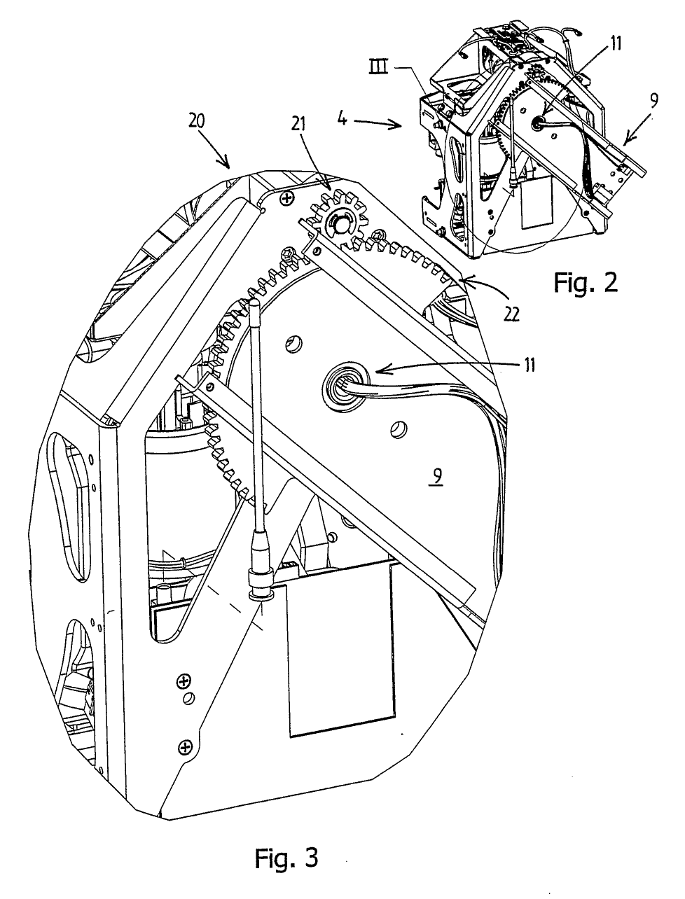

FIG. 2 shows a cut-away view of a motor unit of the chair lift from FIG. 1;

FIG. 3 shows a detail of a positioning device of the stairlift from FIG. 2;

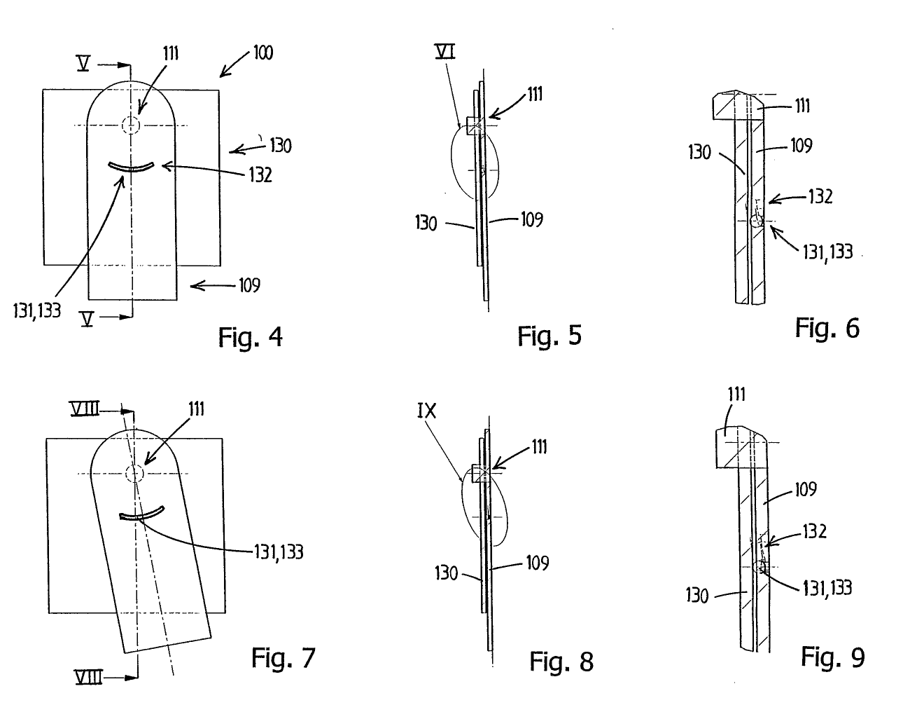

FIG. 4 shows a front view of a first embodiment of a locking device according to the invention;

FIG. 5 shows a cross section on line IV-IV from FIG. 4;

FIG. 6 shows a detail of FIG. 5 on an enlarged scale;

FIG. 7 shows the view of FIG. 4, in which the locking device locks;

FIG. 8 shows a cross section on line VII-VII from FIG. 7;

FIG. 9 shows a detail from FIG. 8;

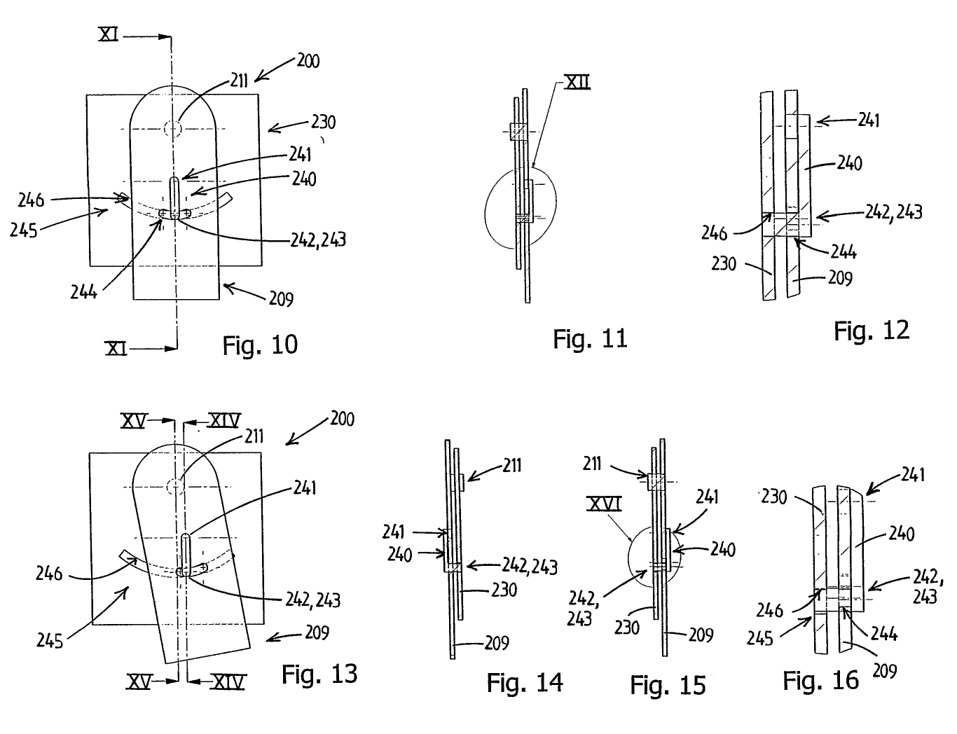

FIG. 10 shows a front view of a second embodiment of a locking device according to the invention;

FIG. 11 shows a cross section on line XI-XI from FIG. 10;

FIG. 12 shows a detail from FIG. 11;

FIG. 13 shows a front view according to FIG. 10, in which the locking device locks;

FIG. 14 shows a cross section on line XIV-XIV from FIG. 13;

FIG. 15 shows a cross section on line XV-XV from FIG. 13; and

FIG. 16 shows a detail from FIG. 15.

An incline lift, in this case a stairlift, is denoted overall in FIG. 1 by reference numeral 1. The stairlift 1 comprises a stairlift unit 2 according to the invention and a guiderail 3, which is shown only partially. The guiderail 3 extends, for example, along a stair and can assume various angles of inclination.

The stairlift unit 2 comprises a chair, or load unit 4, and a conveying unit 5, also referred to as motor unit. The conveying unit 5 is movably connected to the guiderail 3 and can move along the latter for example by means of a motor (not shown) with a toothed wheel in the conveying unit 5, this toothed wheel engaging on a toothed rack (not shown) along the guiderail 3.

The chair 4 comprises a backrest 6 to which folding armrests 7 are fitted. The chair 4 furthermore comprises a seat 8, on the underside of which a chair plate 9 extends downwards. At the bottom of the chair plate 9, a folding footrest 10 is provided. A rotatable connection 11 connects the chair plate 9 and the conveying unit 5.

FIGS. 2 and 3 show a part of the stairlift unit of FIG. 1 in a position which is turned relative to that of FIG. 1 and to the position of use. The housing of the conveying unit 5 and the chair 4 and footrest 10 have been omitted in these figures for the sake of clarity. The chair plate 9 and the conveying unit 5 are provided with a positioning device 20. The positioning device 20 comprises an electric motor (not shown) in the conveying unit 5, which drives a toothed wheel 21. The toothed wheel 21 engages on a semicircular toothed wheel 22 which is fixedly connected to the chair plate 9.

A stairlift unit 2, as described above in connection with FIGS. 1-3, may be provided with a locking device 100 according to the invention, as shown diagrammatically in FIGS. 5-9. The locking device 100 is provided in a chair plate 109. The chair plate 109 is connected to the motor unit by means of a rotatable connection in the form of a shaft 111, only part of which motor unit is shown by means of motor housing 130. The semicircular toothed wheel is only shown diagrammatically in this and the following figures, while the other elements of the positioning device have not been shown for the sake of clarity in these figures.

The locking device 100 comprises a reference element in the form of a ball 131 which is accommodated in a ball slot 132 so as to be movable. The ball 131 also functions as a locking means 133, in cooperation with the motor housing 130.

The ball slot 132 extends along a curved track, the two ends of the curved track being directed upwards slopingly during use. The curved track is in an imaginary plane which is at a slight angle of a few degrees relative to the plane in which the chair plate 109 is. During normal use, the positioning device 20 will ensure that the chair plate 109 maintains a vertical position, that is to say having its centre axis parallel to the direction of the force of gravity, while the motor unit 5 rotates with respect to the chair plate 109 in order to follow the incline angle of the guiderail 3. However, the positioning device 20 could fail, for example as a result of a mechanical defect to the gear transmission, a defect to the electric motor or a defect to the (electronic) control of the electric motor. Although in practice the danger of a failure of this type occurring is not great, it does present a relevant risk, as such a failure would have significant consequences. After all, the centre of gravity of the chair 4 with its user is over the point of rotation 111 to that the chair will tilt when the positioning device 20 fails. As a result, the user of the stairlift 1, usually an elderly or disabled person, will fall off the stairlift unit 2.

When the positioning device 20 fails, a situation such as that shown in FIGS. 7-9 will arise. The chair plate 109 will rotate relative to the motor housing plate 130 and thus also relative to the direction of the force of gravity. Under the force of gravity, the ball 131 will assume a new position in the ball slot 132, which corresponds to the momentary lowest position of the ball slot 132. As a result of the oblique orientation of the plane in which the ball slot 132 is situated, the ball 131 will in this case move in the axial direction of the rotatable connection 111 towards the motor housing plate 130. The ball 131 will in this case come into contact with the motor housing plate 130, as can be seen in FIG. 9. The motor housing plate 130 blocks a further axial movement of the ball 131 and thereby acts as a locking surface. As a further axial displacement of the ball 131 is impossible, the chair plate 109 is not able to rotate further and jams at an angle relative to the direction of the force of gravity which is 5° to 6° in practice. Although the motor housing plate 130 has been shown in a horizontal position in this example, it will be clear that this position is not relevant for the functioning of the locking device 100.

FIGS. 10-16 show a second embodiment of a locking device 200, which may be used, for example in a stairlift unit 2, as described above. A chair plate 209 is connected to a conveying unit by means of a rotatable connection 211, of which conveying unit only the motor housing plate 230 is shown.

The locking device comprises a pendulum 240 which is rotatably connected to the chair plate 209 by means of a pendulum shaft 241. A pin 242 is connected to the bottom end of the pendulum 240, which pin 242 acts as reference element and locking means 243.

The pin 242 extends through a pendulum slot 244. The pendulum slot 244 is cut out of the chair plate 209 and extends over an arc length which is greater than the angle at which the locking device 200 locks the stairlift unit 2. The function of the pendulum slot 244 is to lead the pin 242 from the pendulum 240 to a locking slot 245, which has been cut into the motor housing plate 230. The wall of the curved locking slot 245 which is at the top during use acts as locking surface 246.

In extraordinary circumstances, as described above with respect to the first embodiment, the chair plate 209 will assume an undesirable angle relative to the direction of the force of gravity in use. Due to the force of gravity, the pendulum 240 will maintain an orientation which is identical to the direction of this force of gravity. As a result, the pendulum 240 has in fact been rotated relative to the chair plate 209. Since the pendulum shaft 241 and the shaft 211 do not coincide, the radial distance of the pin 242 relative to the shaft 211 decreases. As a result thereof, the pin 242 will jam against the locking surface 246 of the locking slot 245, thus preventing the chair plate 209 from rotating further.

Many variants are possible in addition to the embodiments shown. Thus, the chair can be replaced with another load unit, such as for example a platform for a wheelchair. Also, the guiderail does not have to extend along a staircase, but may be fitted along any arbitrary incline over which people or other loads have to be carried.

It is also possible to use another type of guide along which the incline lift unit moves, such as a track, and the drive for the movement of the incline lift unit may be provided outside as well as inside of the incline lift unit.

The positioning device may be of a different design, for example by placing the teeth of the semicircular toothed wheel on the load unit at an angle, and placing the shaft of the driving toothed wheel of the conveying unit at a corresponding angle. The positioning may also be effected by means of a screw wheel, spindle or actuator.

The reference element may in part be provided on the conveying unit, instead of on the load unit. With an embodiment using a ball in a slot, such a slot may be curved in a second direction instead of in an oblique plane, by which an axial displacement of the ball is likewise achieved.

In an embodiment using slots in both the load unit and the conveying unit, with both slots having different radii, similar to the second embodiment described above, the pendulum with pin can be replaced by a pin without pendulum, provided that means have been provided to prevent too large an axial displacement of this pin.

In one embodiment with a pendulum and a locking means which is provided on the pendulum, the corresponding pendulum shaft may be placed at an inclined angle. As a result thereof, a deflection by the pendulum relative to the load unit results in an axial displacement of the locking means relative to the rotatable connection between the load unit and the conveying unit.

Furthermore, embodiments are possible using a pendulum, which—as soon as the latter shows a deflection relative to the load unit—unlocks a locking means, which effects a locking of the load unit relative to the conveying unit, for example by spring tension or by the force of gravity.

Finally, embodiments are possible in which a reference element can follow a curved track in another manner than in those shown, for example by an annular reference element which moves along and around a curved bar.

In this manner, the invention provides an incline lift unit with a locking device, which ensures a secure locking of the load unit, if the positioning device should fail at all. The locking device does not depend on electrical or otherwise complicated or vulnerable means in order to function. By contrast, the locking device according to the invention can be produced relatively simply and thus inexpensively.

1. Incline lift unit (2), comprising a conveying unit (5), a load unit (4) which is rotatably connected to the conveying unit (5) by means of a rotatable connection (11, 111), a positioning device (20), and a locking device (100), in which
the positioning device (20) is designed to turn the load unit (4) with respect to the conveying unit (5) in such a manner that, in use, the load unit (4) assumes a desired load orientation relative to the force of gravity, and
the locking device (100) comprises a locking means (133), the locking means (133) locking the rotatable connection (11, 111) between the load unit (4) and the conveying unit (5) if the load unit (4) has assumed an undesirable load orientation, wherein
the locking device (100) comprises a reference element (131) which is movable with respect to the load unit (4) and the conveying unit (5), its position with respect to the load unit (4) being determined by the direction of the force of gravity,
the load unit (4) is able to assume at least a neutral position and a locking position at the desired and undesired load orientation, respectively, with respect to the reference element (131), and
the reference element (131) is mechanically connected to the locking means (133), the reference element (131) activating the locking means (133) in the locking position.

2. Incline lift unit (2) according to claim 1, in which the reference element (131) is fixedly connected to the locking means (133).

3. Incline lift unit (2) according to claim 2, in which the reference element (131) forms a single entity with the locking means (133).

4. Incline lift unit (2) according to claim 1, in which the reference element (131) is movable along a curved track (132) relative to the load unit (4).

5. Incline lift unit (2) according to claim 4, in which the locking device (100) comprises a pendulum (240) to which the reference element (131) is connected.

6. Incline lift unit (2) according to claim 1, in which the locking device (100) comprises a slot (132).

7. Incline lift unit (2) according to claim 6, in which the reference element (131) is a ball, which is accommodated in the slot (132) so as to be movable.

8. Incline lift unit (2) according to claim 6, in which the slot (132) is provided in the load unit (4) and the distance of the slot (132) to the conveying unit (5) along the slot (132) varies.

9. Incline lift unit (2) according to claim 1, in which, in the locking position, at least one of the radial and axial positions of the reference element (131) relative to the rotatable connection (11, 111) differs from the corresponding position in the neutral position.

10. Incline lift unit (2) according to claim 1, in which the locking means (133) is movable in a substantially radial and/or a substantially axial direction with respect to the rotatable connection (11, 111).

11. Locking device (100) clearly intended for an incline lift unit (2) according to claim 1.
